(19) United States
(12) Patent Application Publication
(10) Pub. No.: US 2012/0264488 A1
(43) Pub. Date: Oct. 18, 2012

(54) COMMUNICATION DEVICE, SYSTEM, AND METHOD FOR AUTOMATICALLY DISABLING DISPLAY UNIT

(75) Inventor: CHI-SHENG GE, Tu-Cheng (TW)

(73) Assignee: HON HAI PRECISION INDUSTRY CO., LTD., Tu-Cheng (TW)

(21) Appl. No.: 13/188,502

(22) Filed: Jul. 22, 2011

(30) Foreign Application Priority Data
Apr. 15, 2011 (TW) 100113077

(51) Int. Cl. H04W 88/02

(52) U.S. Cl. 455/566

(57) ABSTRACT

The communication device includes a display unit, a communication unit, a speaker, a detecting unit, and a processing unit. The processing unit is used to receive and process audio signals. The speaker is used to reproduce the processed audio signals and emit sound waves. The detecting unit is used to detect the sound waves and acquire an intensity level. The processing unit is also used to compare the intensity level with a predetermined intensity level, disabling the display unit when the intensity level is greater than the predetermined intensity level, and enabling the display unit when the intensity level is smaller than or equal to the predetermined intensity level.

### BACKGROUND

1. Technical Field

The disclosed embodiments relate to communication devices, and more particularly to a communication device, a system, and a method that can automatically disable a display unit.

2. Description of Related Art

Some display units of communication devices, such as mobile phones, remain on during phone calls even though the caller is not viewing the display, which is a waste of energy.

What is needed, therefore, is an improvement in the art to overcome the above described limitations.

### BRIEF DESCRIPTION OF THE DRAWINGS

The components of the drawings are not necessarily drawn to scale, the emphasis instead being placed upon clearly illustrating the principles of a communication device, a system, and a method for automatically disabling a display unit. Moreover, in the drawings, like reference numerals designate corresponding parts throughout two views.

FIG. 1 is a block diagram showing a system for automatically disabling a display unit in accordance with one embodiment.

FIG. 2 is a flowchart showing a method for automatically disabling a display unit in accordance with the one embodiment.

### DETAILED DESCRIPTION

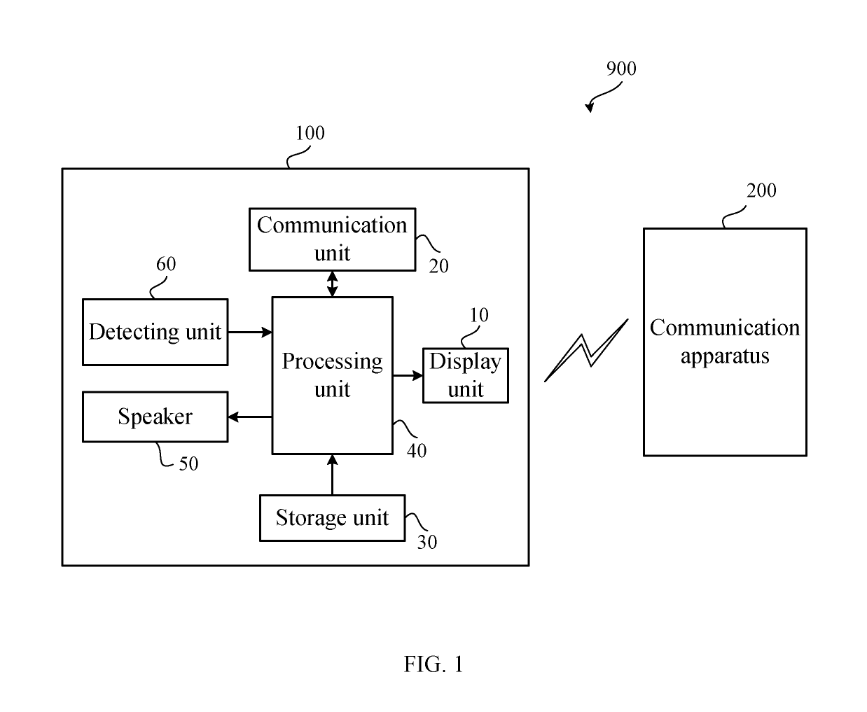

Referring to FIG. 1, a system 900 for automatically disabling a display unit 10 is illustrated. The system 900 includes a communication device 100 and a communication apparatus 200. In this embodiment, the communication device 100 can be a mobile phone, in other embodiments, the communication device 100 can be a personal digital assistant (PDA) etc. The communication device 100 receives a request from the communication apparatus 200.

The communication device 100 includes a display unit 10, a communication unit 20, a storage unit 30, a processing unit 40, a speaker 50, and a detecting unit 60. The communication unit 20 is configured for establishing a communication link between the communication device 100 and the communication apparatus 200 according to the request and a user instruction.

The storage unit 30 stores a predetermined intensity level.

The processing unit 40 is configured for receiving audio signals from the communication apparatus 200 when the communication link has been established, and processing the audio signals, the processing of the audio signals includes demodulation and decoding of the audio signals.

The speaker 50 is configured for reproducing the processed audio signals to emit sound waves.

The detecting unit 60 is configured for detecting the sound waves emitted by the speaker 50 and measuring an intensity of the detected sound waves to acquire an intensity level. In this embodiment, the detecting unit 60 is disposed adjacent to the speaker 50 to detect the sound waves. The detected sound waves includes the sound waves emitted directly to the detecting unit 60 from the speaker 50 and any of the sound waves reflected back from a nearby object such as a user's face.

The processing unit 40 further compares the intensity level measured by the detecting unit 60 with the predetermined intensity level. When the intensity level is greater than the predetermined intensity level, the processing unit 40 disables the display unit 10; when the intensity level is less than or equal to the predetermined intensity level, the processing unit 40 enables the display unit 10.

When users place calls and are not using a speaker phone mode they hold the phone close to or against their face. In this situation, the intensity level detected by the detecting unit 60 will be greater than the predetermined intensity level because of the sound reflecting back from the user's face, and the processing unit 40 disables the display unit 10 to save energy. When the user moves the phone away from their face either at the end of the call or during the call if they need to consult the display, the intensity level detected by the detecting unit 60 will become less than or equal to the predetermined intensity level, then the processing unit 40 re-enables the display unit 10.

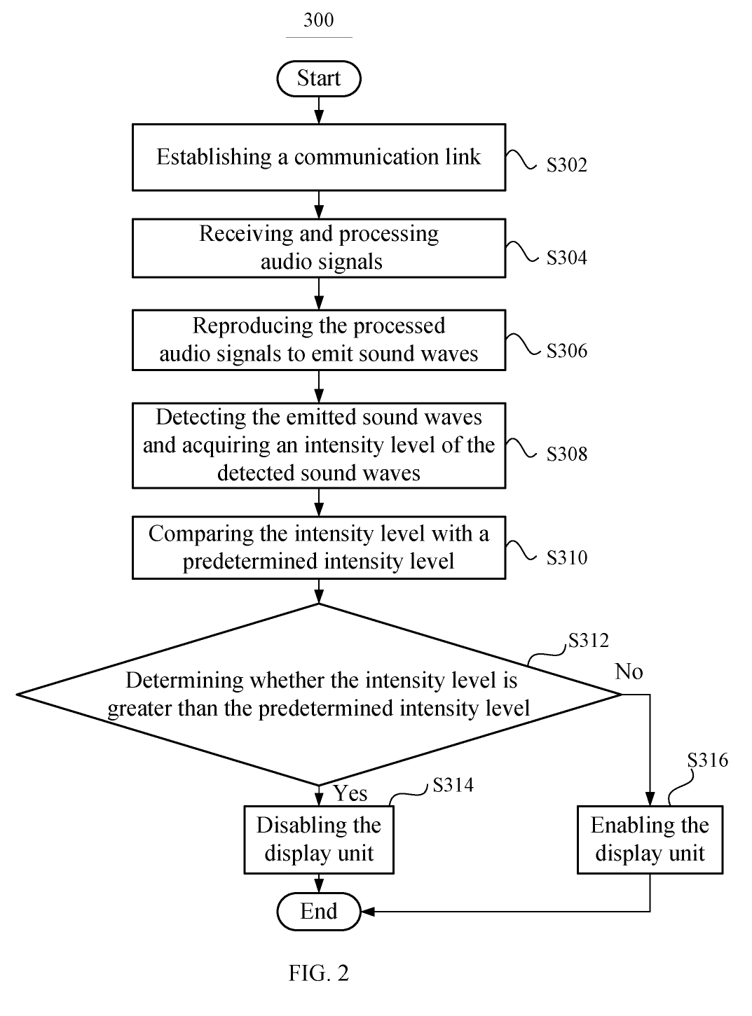

Referring to FIG. 2, a flowchart showing a method 300 for automatically disabling a display unit 10 is illustrated. The method 300 is implemented by the communication device 100 when the communication device 100 receives a request from the communication apparatus 200. The method 300 includes the following steps.

In step S302, the communication unit 20 establishes a communication link between the communication device 100 and the communication apparatus 200 according to the request and a user instruction.

In step S304, the processing unit 40 receives the audio signals from the communication apparatus 200 when the communication link has been established, and processes the audio signals.

In step S306, the speaker 50 reproduces the processed audio signals to emit sound waves.

In step S308, the detecting unit 60 detects the emitted sound waves and measures an intensity of the detected sound waves to acquire an intensity level. In this embodiment, the detecting unit 60 is disposed adjacent to the speaker 50 to detect the sound waves. The detected sound waves include the sound waves emitted directly to the detecting unit 60 from the speaker 50 and any of the sound waves reflected back to the detecting unit 60 by the user's face or other objects.

In step S310, the processing unit 40 compares the intensity level with the predetermined intensity level.

In step S312, the processing unit 40 determines whether the intensity level is greater than the predetermined intensity level. If the intensity level is greater than the predetermined intensity level, the flow goes to S314; if the intensity level is smaller than or equal to the predetermined intensity level, the flow goes to S316.

In step S314, the processing unit 60 disables the display unit 10.

In step S316, the processing unit 60 enables the display unit 10 or if the display unit 10 is already enabled, leaves it enabled.

Alternative embodiments will become apparent to those skilled in the art without departing from the spirit and scope of what is claimed. Accordingly, the present invention should be deemed not to be limited to the above detailed description, but rather only by the claims that follow and equivalents thereof.

1. A communication device receiving a request from a communication apparatus, the communication device comprising:
a communication unit for being responsive to the request and a user instruction to establish a communication link between the communication device and the communication apparatus;
a display unit;
a processing unit for receiving audio signals from the communication apparatus when the communication link has been established, and processing the audio signals;
a speaker for reproducing the processed audio signals to emit sound waves; and
a detecting unit disposed adjacent to the speaker for detecting the sound waves, and measuring an intensity of the detected sound waves to acquire an intensity level, wherein the detected sound waves comprise the sound waves emitted directly to the detecting unit from the speaker and the sound waves reflected from an object back to the detecting unit when the sound waves emitted by the speaker reach the object and are reflected by the object;
wherein the processing unit further compares the intensity level with a predetermined intensity level, and disables the display unit when the intensity level is greater than the predetermined intensity level.

2. The communication device of claim 1, wherein the processing unit enables the display unit when the intensity level is smaller than or equal to the predetermined intensity level.

3. (canceled)

4. The communication device of claim 1, wherein the object is the user's face.

5. The communication device of claim 1, wherein the communication device is a mobile phone.

6. The communication device of claim 1, further comprising:
a storage unit for storing a predetermined intensity level.

7. A method for automatically disabling a display unit of a communication device, the communication device receiving a request from a communication apparatus, the method comprising:
establishing a communication link between the communication device and the communication apparatus according to the request and a user instruction;
receiving audio signals from the communication apparatus when the communication link has been established and processing the audio signals;
reproducing the processed audio signals to emit sound waves;
detecting the emitted sound waves and measuring an intensity of the detected sound waves to acquire an intensity level, wherein the detected sound waves comprise the sound waves emitted directly to the detecting unit from the speaker and the sound waves reflected from an object back to the detecting unit when the sound waves emitted by the speaker reach the object and are reflected by the object; and
comparing the intensity level with a predetermined intensity level and disabling the display unit when the intensity level is greater than the predetermined intensity level.

8. The method of claim 7, further comprising:
enabling the display unit when the intensity level is smaller than or equal to the predetermined intensity level.

9. The method of claim 7, wherein the step of reproducing the processed audio signals to emit sound waves is implemented by a speaker, the step of detecting the emitted sound waves is implemented by a detecting unit, the detecting unit is disposed adjacent to the speaker.

10. The method of claim 7, wherein the object is a user's face.

11. The method of claim 7, wherein the communication device is a mobile phone.

12. A system, comprising:
a communication apparatus; and
a communication device receiving a request from the communication apparatus, the communication device comprising:
a communication unit for establishing a communication link between the communication device and the communication apparatus according to the request and a user instruction;
a display unit;
a processing unit for receiving audio signals from the communication apparatus when the communication link has been established, and processing the audio signals;
a speaker for reproducing the processed audio signals to emit sound waves; and
a detecting unit for detecting the sound waves emitted by the speaker, and measuring an intensity of the detected sound waves to acquire an intensity level, wherein the detecting unit is disposed adjacent to the speaker, the detected sound waves comprise the sound waves emitted directly to the detecting unit from the speaker and the sound waves reflected from an object back to the detecting unit when the sound waves emitted by the speaker reach the object and are reflected by the object;
wherein the processing unit further compares the intensity level with a predetermined intensity level, and disables the display unit when the intensity level is greater than the predetermined intensity level.

13. The system of claim 12, wherein the processing unit enables the display unit when the intensity level is smaller than or equal to the predetermined intensity level.

14. (canceled)

15. The system of claim 12, wherein the object is the user's face.

16. The system of claim 12, wherein the communication apparatus and the communication device are mobile phones.

17. The system of claim 12, wherein the communication device further comprises a storage unit for storing a predetermined intensity level.
